(19) United States
(12) Patent Application Publication
(10) Pub. No.: US 2009/0262081 A1
(43) Pub. Date: Oct. 22, 2009

(54) LIGHT-EMITTING MODULE AND KEYBOARD HAVING THE SAME

(75) Inventors: Chao-Lung CHANG, Taoyuan (TW); Liang-Ta YEH, Taoyuan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DARFON ELECTRONICS CORPORATION, Taoyuan (TW)

(21) Appl. No.: 12/424,144

(22) Filed: Apr. 15, 2009

(30) Foreign Application Priority Data
Apr. 22, 2008 (TW) 097114621

(51) Int. Cl. G06F 3/02; F21V 7/04

(52) U.S. Cl. 345/170; 362/616; 362/612

(57) ABSTRACT

The present invention provides a keyboard and a light-emitting module thereof. The light-emitting module includes a light guide element, a first light source and a second light source. The light guide element includes a first light guide region, a second light guide region, and a masking region located between the first light guide region and the second light guide region. The first light source emits a first color light to the first light guide region. The second light source emits a second color light to the second light guide region. The first light guide region and the second light guide region are separated by the masking region, so that the first color light and the second color light are not mixed.

### CROSS REFERENCE TO RELATED APPLICATIONS

This application claims the right of priority based on Taiwan Patent Application No 97114621 entitled “LIGHT-EMITTING MODULE AND KEYBOARD HAVING THE SAME” filed on Apr. 22, 2008, which is incorporated herein by reference and assigned to the assignee herein.

### FIELD OF THE INVENTION

This invention relates to a light-emitting module, and more particularly relates to a light-emitting module having different illuminant regions in different colors and a keyboard with the same.

### BACKGROUND OF THE INVENTION

Following the electronics-developing trend, electronic products with inputting pads such as computers, electronic translators, and mobile phones have become more and more popular. Normally, operating such electronic products in a dark or dim environment is inconvenient.

To continuously operate keyboards and do the keystroke, one of the conventional approaches is to provide an electroluminance plate as a light source installed within the keyboard. The keyboard will shine when the electroluminance plate being activated and sending light out. Since the electroluminescence plate typically irradiates light in a single color, the keyboard shines monochromatically. Consequently, it must rely upon enough luminance intensity in order to clearly see and distinguish from the pads of the keyboard. Another approach is to build a dot light source for each single pad, for example, respectively disposing a LED (light emitting diodes) or an OLED (Organic Electroluminescence Diodes) under each single pad. However, such a way will increase the product cost and adversely render a heat dissipation problem. Therefore, to provide a novel light-emitting module for solving the above-mentioned problems is desirable.

### SUMMARY OF THE INVENTION

One aspect of the present invention is to provide a light-emitting module being easily assembled with lower cost. The light-emitting module is capable of locally emitting light in different or the same colors.

According to one embodiment, the present invention provides a light-emitting module comprising a light guide element, a first light source and a second light source. The light guide element includes a first light guide region, a second light guide region, and a masking region located between the first light guide region and the second light guide region. The first light source emits a first color light to the first light guide region. The second light source emits a second color light to the second light guide region. The first light guide region and the second light guide region are separated by the masking region, so that the first color light and the second color light are not mixed.

In the abovementioned embodiment, the masking region is formed with a predetermined profile surrounding the second light guide region. In another embodiment, the masking region is of a gap, and the first light guide region and the second light region are of two light guide plates independent from each other. In yet another embodiment, the first light guide region, the second light guide region and the masking region are integrated to be a light guide plate.

Another aspect of the present invention is to provide a keyboard capable of locally emitting light in different colors. By way of various regions in different colors, the accuracy pressing the right keypad by users is increased.

According to one embedment, the present invention provides a keyboard including a keypad module; and a light emitting module disposed under the keypad module. The light-emitting module includes a light guide element, a first light source and a second light source. The light guide element includes a first light guide region, a second light guide region, and a masking region located between the first light guide region and the second light guide region. The first light source emits a first color light to the first light guide region. The second light source emits a second color light to the second light guide region. The first light guide region and the second light guide region are separated by the masking region, so that the first color light and the second color light are not mixed. Further, the first color light or the second color light can selectively illuminate the keypad module on a predetermined position.

In the aforementioned embodiment, the first light source and the second light source are preferably light emitting diodes (LED). In another embodiment, the masking region is a gap formed with a predetermined profile surrounding the second light guide region. In yet another embodiment, the light-emitting module includes a masking element disposed above the light guide element. The masking element is formed with a predetermined pattern for reduction of light scattering.

The objects and the features of the present invention may best be understood by reference to the detailed description with the accompanying drawings.

### BRIEF DESCRIPTION OF THE DRAWINGS

FIG. 1 is a top view illustrating a keyboard in accordance with a first embodiment of the present invention.

FIG. 2 is a cross-sectional view illustrating the keyboard along the line A-A′ of FIG. 1 in accordance with the first embodiment of the present invention,

FIG. 3 is a top view illustrating a light guide element in accordance with the first embodiment of the present invention.

FIG. 4 is a cross-sectional view illustrating a keyboard in accordance with a second embodiment of the present invention.

FIG. 5 is a top view illustrating a light guide element in accordance with the second embodiment of the present invention.

FIG. 6 is a cross-sectional view illustrating a keyboard in accordance with a third embodiment of the present invention.

### DETAILED DESCRIPTION OF THE INVENTION

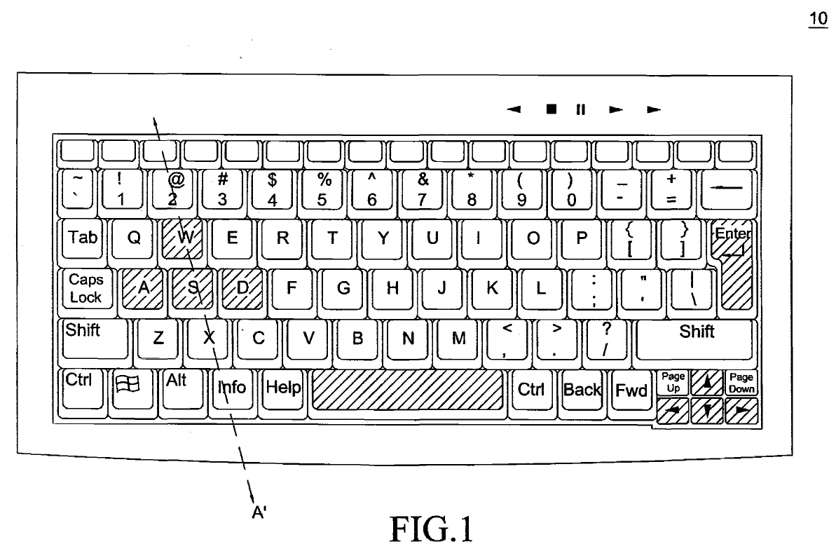

The preferred embodiments of the present invention will now be described in greater details by referring to FIGS. 1-4 that accompany the present application, wherein similar elements are represented with alike reference numerals. It should be noted that the features illustrated in the drawings are not necessarily drawn to scale. Descriptions of well-known components, materials, and process techniques are omitted so as to not unnecessarily obscure the embodiments of the invention. Any devices, components, materials, and steps described in the embodiments are only for illustration and not intended to limit the scope of the present invention,

FIG. 1 depicts a keyboard 10 in a top view in accordance with a first embodiment of the present invention. In the first embodiment, the keyboard 10 is illustrated for inputting data into computers such as notebook or desktop, but the invention is not limited thereto. The term “keyboard” in the present invention can refer to any input unit for receiving data and transferring it into a machine or a circuit. For example, the keyboard can be a set of keypads on the mobile phone or the electronic translators. As shown in FIG. 1, the keyboard 10 is formed with multiple keypads, such as number pads, character pads, alphabet pads, navigation pads, space pad, the input pad (Enter), arrow pads and function pads, etc., wherein the alphabet pads “W” “A” “S” “D”, the space pad, the input pad (Enter) and the arrow pads are illuminated in a color that is different from the other pads.

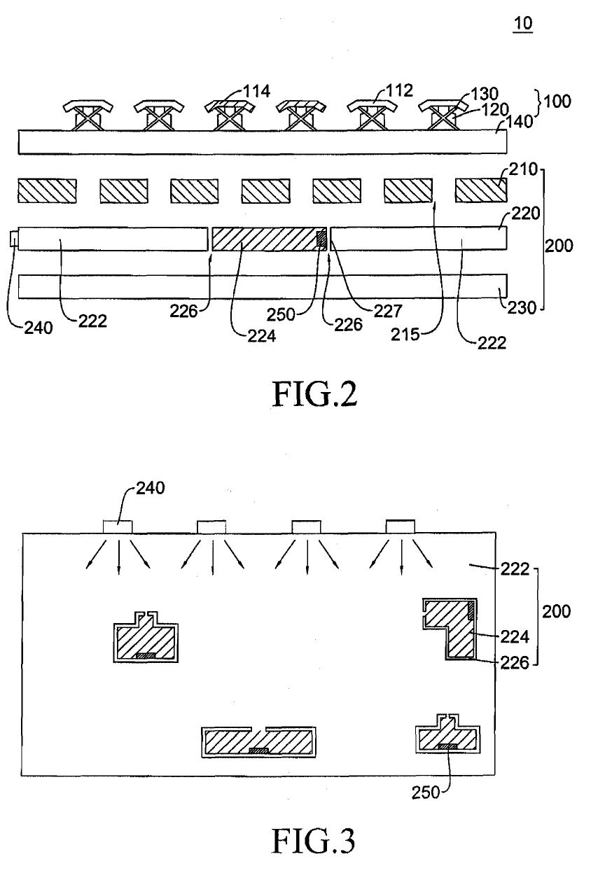

FIG.2 illustrated the keyboard 10 in a cross-sectional view along the line A-A′ of FIG. 1. As shown in FIG. 2, the keyboard 10 includes a keypad module 100 and a light-emitting module 200 disposed under the keypad module 100. The keypad module 100 mainly includes pads 112 and 114, an elastomer 120, a holder 130 and a thin film circuit 140. Through the keyboard 10, users can display information on monitors or control programs implemented in computers by providing instructions via the pads 112 and 114.

As shown in FIG. 2, the light-emitting module 200 includes a masking element 210, a light guide element 220, a reflector 230, a first light source 240 and a second light source 250. The light guide element 220 includes a first light guide region 222, a second light guide region 224 and a masking region 226. As shown, the masking region 226 can be a gap separating the first light guide region 222 from the second light guide region 224. Preferably, for enhancing the masking effects, a light masking material or a reflection material can be formed on the interfaces of the gap (i.e. the masking region 226) and the first light guide region 222 and the second light guide region 224. The first light source 240 emits a first color light (e.g. white light) to the first light guide region 222. The second light source 250 emits a second color light (e.g. blue light) to the second light guide region 224. The first light guide region 222 and the second light guide region 224 are separated by the masking region 226, so that the first color light and the second color light are not mixed.

In the first embodiment, the masking element 210 can be a thin film containing light-shielding pigments. Alternatively, the light shielding pigments can be a coating on one side of the thin film. The thin film can be made of resin, such as PET or PVC. The masking element 210 is formed with a pattern where the light from the first light source 240 or the second light source 250 can pass through. In this way, the light being scattered is also reduced. Specifically, the masking element 210 can be formed with multiple transparent portions 215 corresponding to the pads to be illuminated on the keypad module 100. The light directed by the light guide element 220 can illuminate the corresponding pads 112 and 114. Further, for preventing the light scattering via the slots between the pads, the multiple transparent portions 215 of the masking element 210 are preferably smaller than the pads. As shown in FIG. 2, the multiple transparent portions 215 are illustrated as openings, but the invention is not limited thereto. In another embodiments, the multiple transparent portions 215 are illustrated as portions made of high transparent materials, such as PET, PC or PMMA. On the other aspect, it should be understood that the numbers, shapes, sizes and distributions of the multiple transparent portions 215 can vary by ordinary skills in the art depending upon design needs in practical.

FIG. 3 illustrates the light guide element 220 in a top view according to the first embodiment of the present invention. The light guide element 220 (e.g. a light guide plate, LGP) is beneath the masking element 210. For light transportation, highly transparent materials such as PC or PMMA preferably make the light guide element 220. As aforementioned, the light guide element 220 includes the first light guide region 222, the second light guide region 224 and the masking region 226. Preferably, the first light guide region 222, the second light guide region 224 and the masking region 226 are integrated together. Specifically, the integration can be conducted by forming openings with predetermined shapes (e.g. a slot) into the light guide element 220 utilizing pressing or milling. The openings surrounds the second light guide region 224. Note that the integration of the first light guide region 222, the second light guide region 224 and the masking region 226 is for illustration, and the present invention is not limited thereto. In another embodiment, the first light guide region 222 and the second light guide region 224 are not integrated. Specifically, this can be conducted by providing a first light guide plate and a second light guide plate wherein the first light guide plate is formed with a hole for receiving the second light guide plate. Note that the hole, being circular or rectangular, should be larger than the second light guide plate thereby forming a slot between the first light guide plate and the second light guide plate. That is, the first light guide plate is the first light guide region 222; the second light guide plate is the second light guide region 224; and the slot is the masking region 226. Namely, the masking region 224 separates the first light guide region 222 from the second light guide region 226. The embodiment is shown in FIG. 5.

Referring to FIGS. 2 and 3, the multiple first light sources 240 are adjacent to at least one side of the first light guide region 222. In such a configuration, the first-color light from the multiple first light sources 240, being guided by the light guide plate 220, will evenly spread out over the surface of the light guide plate 220 and then pass through the masking element 210 via the transparent portions to arrive at the specific pads (e.g. 112) of the keyboard module 100. On the other hand, at least one of the second light source 250 are placed within each second light guide region 250. In such a configuration, the second-color light from the second light sources 250, being guided by the light guide plate 220, will pass through the masking element 210 via the transparent portions to arrive at the specific pads (e.g. 114) of the keyboard module I 00. Note that the position, size, numbers and distribution of the second light guide region 244 can vary depending upon the specific pads to be illuminated in the second color light. For example, it can be a convex beneath the alphabet pads “W” “A” “S” “D”, or a rectangle beneath the space pad. Alternatively, for enhancing the light utilization efficiency, a reflector 230 can be additionally placed under the light guide element 220. The reflector 230 can reflect the scattered light back to the light guide plate.

Light emitting diodes (LEDs) are widely applied in various fields due to its strengths of high brininess, high luminous efficiency, low power consumption and high reliability. The structures of LEDs are small and compact so as to be incorporated into the light guide element. LEDs can generate light with multiple colors including white, red, blue, yellow, green etc. Multi-color LEDs are equipped with RGB light emitting diodes chips to provide colorful images. In the first embodiment, the first light source 240 and the second light source 250 are illustrated as LEDs for emitting different color light. For example, the first light source 240 is a white light LED and the second light source 250 is a blue light LED. As a result, the keypad module 100 will exhibit a white-color area at the place of pad 112 and a blue-color area at the place of pad 114. In another embodiment, at least one of the first light source 240 and the second light source 250 is a multi-LED. Therefore, the whole keyboard can exhibit only a single color or various colors in different areas.

The aforementioned “W” “A” “S” “D” pads, the space pad, the input pad (Enter) and the arrow pads are frequently used when playing computer games. If these pads are highlighted by specific colors, it will be very helpful to the player due to the increased accuracy for inputting in a dark environment. In the keyboard 10 of the first embodiment, the first light source is placed on the first light guide region 220 to let the pad 112 present in a first color. Furthermore, the second light source 250 for the second color is placed on the second light guide region 224 corresponding to the location of the “W” “A” “S” “D” pads, the space pad, the input pad (Enter) and the arrow pads. These pads will present in a second color so as to be distinguished from other pads.

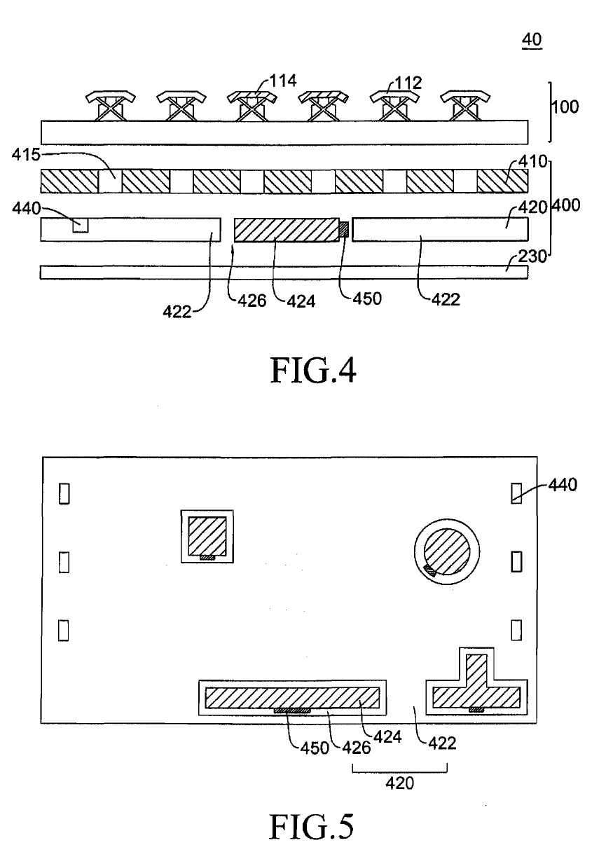

FIG. 4 illustrates a cross sectional view of a keyboard 40 in accordance with a second embodiment of the present invention. The keyboard 40 includes a keypad module 100 and a light-emitting module 400. The light-emitting module includes a masking element 410, a light guide element 420, a first light source 440 and a second light source 450. The masking element 410 is formed with multiple transparent portions 415. The light from the second light guide element 420 can pass through the transparent portion 415 and then illuminate the corresponding pads. For example, the first color light illuminates the pad 112 and the second color light illuminates the pad 114. In the embedment, the transparent portion 415 is made of transparent plastic materials, such as PET, PC or PMMA. For preventing redundancy, to describe portions of the keyboard 40 similar to those illustrated in the first embodiment is omitted herein.

FIG. 5 illustrates a top view of the light guide element 420 in accordance with the second embodiment of the present invention. In the second embedment, the light guide element 420 includes a first light guide region 422, a second light guide region 424 and a masking region 426. The first light source 440 is disposed within the first light guide region 422. The second light source 450 is disposed on a sidewall where the masking region 426 is adjacent to the second light guide region 424. As shown in FIG. 5, the masking region 426 separates the first light guide plate (i.e. the first light guide region 422) from the second light guide plate (i.e. the second light guide region 424). In this manner, the first color light and the second color light are not mixed. As aforementioned, the light guide element 420 can be formed by pressing or milling. The first light guide region 422 and the second light guide region 424 can be integrated or not. The light guide element 420 is patterned to form a slot or groove in a predetermined shape (e.g. circular, rectangular or convex). The slot or groove is the masking region 425 between the first light guide region 422 and the second light guide region 424. As shown in FIG. 5, the masking region 426 completely surrounds the second light guide region 424 so that the first light guide region 422 and the second light guide region 424 are independent and therefore blocking light from mixing is more effectual. In addition, to coat light shielding materials on at least one sidewall of the making region 426 is preferred for enhancing the light blocking effects. Alternatively, the masking region 426 may be filled with light shielding materials such as black sponge or reflective materials such as Aluminum.

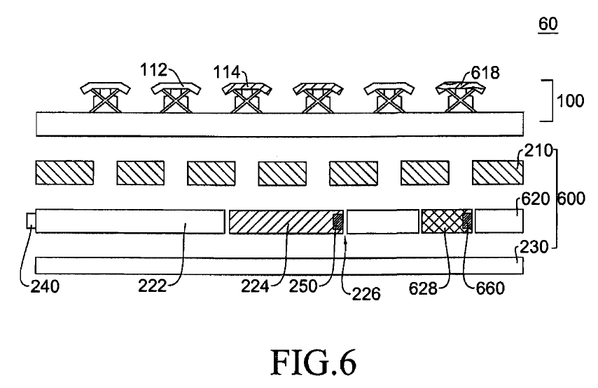

FIG. 6 illustrates a cross sectional view of a keyboard 60 in accordance with a third embodiment of the present invention. The keyboard 60 includes a keypad module 100 and a light-emitting module 600. The keyboard also includes a masking element 210, a reflector 230, a first light source 240, a second light source 250 and other related components which might be functioned similar to those illustrated in the first and second embodiments. Descriptions of the similarities are omitted. The light emitting element 620 includes a first light guide region 222, a second light guide region 224, a third light region 628 and a masking region 226. The first light source 240 emitting the first color light is disposed on a side of the first light guide region 222. The second light source 250 emitting the second color light is disposed within the second light guide region. The third light source 660 emitting the third color light is disposed within the third light guide region 628. In the embodiment, the first, second and third light sources are illustrated as LEDs, which respectively emits light in different colors. Note that in the embodiment, the masking regions 226 is located between the first light guide region 222 and the second light guide region 224, the first light guide region 222 and the third light guide region 628, and/or the second light guide region 224 and the third light guide region 628. In this configuration, the first color light, the second color light and the third color light are not mixed. The keypad module 100 will be illuminated by the first, second and third color light respectively on some specific pads (e.g. the pads 112, 114 and 618).

In view of the above mentioned, it should be understood that the light emitting keyboard 60 is capable of locally emitting light in different color, and accordingly the convenience and the accuracy for searching the keypad and doing the keystroke are increased. It should be noted that, although the present invention illustrates a keypad module having three portions illuminated by three distinct light sources in different colors, it is not limited thereto. The present invention also includes keypad modules having four or more portions with four or more distinct light sources in different colors depending upon the needs in applications.

Although specific embodiments have been illustrated and described, it will be obvious to those skilled in the art that various modifications may be made without departing from what is intended to be limited solely by the appended claims.

1. A light-emitting module, comprising:
a light guide element having a first light guide region, a second light guide region, and a masking region located between the first light guide region and the second light guide region;
a first light source emitting a first color light to the first light guide region; and
a second light source emitting a second color light to the second light guide region, wherein the first light guide region and the second light guide region are separated by the masking region, so that the first color light and the second color light are not mixed.

2. The light-emitting module according to claim 1, wherein the first light source is adjacent to a side of the light guide element.

3. The light-emitting module according to claim 1, wherein the first light source is located within the first light guide region.

4. The light-emitting module according to claim 1, wherein the second light source is located within the second light guide region.

5. The light-emitting module according to claim 1, wherein the second light source is located on a sidewall where the masking region is adjacent to the second light guide region.

6. The light-emitting module according to claim 1, wherein the first light source and the second light source are light emitting diodes (LEDs).

7. The light-emitting module according to claim 1, wherein the masking region contains a light shielding material.

8. The light-emitting module according to claim 1, wherein the masking region contains a reflective material.

9. The light-emitting module according to claim 1, wherein the masking region is formed with a predetermined outline surrounding the second light guide region.

10. The light-emitting module according to claim 1, wherein the masking region is a gap.

11. The light-emitting module according to claim 1, wherein the first light guide regions and the second light guide region are independent light guide plates.

12. The light-emitting module according to claim 1, wherein the first light guide region, the second light guide region and the third light guide regions are integrated into a light guide plate.

13. A keyboard, comprising a keypad module and a light-emitting module under the keypad module, the light-emitting module comprising:
a light guide element having a first light guide region, a second light guide region, and a masking region located between the first light guide region and the second light guide region;
a first light source emitting a first color light to the first light guide region; and
a second light source emitting a second color light to the second light guide region, wherein the first light guide region and the second light guide region are separated by the masking region so that the first color light and the second color light are not mixed, and the keypad module can selectively be illuminated by the first color light or the second color light on a predetermined position.

14. The keyboard according to claim 13, wherein the first light source is within the first light guide region.

15. The keyboard according to claim 13, wherein the second light source is within in the second light guide region.

16. The keyboard according to claim 13, wherein the masking region is formed with a predetermined outline surrounding the second light guide region.

17. The keyboard according to claim 13, wherein the masking region is a gap.

18. The keyboard according to claim 13, wherein the first light source and the second light source are light emitting diodes (LEDs).

19. The keyboard according to claim 13, wherein the light emitting module further comprises a shielding element above the light guide element, the shielding element having a predetermined pattern for reduction of light scattering.

20. The keyboard according to claim 13, wherein the light-emitting module further comprises a reflector beneath the light guide element.
